(19) United States
(12) Patent Application Publication
(10) Pub. No.: US 2013/0192218 A1
(43) Pub. Date: Aug. 1, 2013

(54) ENERGY CONVERSION DEVICE

(71) Applicants: Anne Briffett, Inverness (GB); Lorn Macdonald, Inverness (GB)

(72) Inventors: Anne Briffett, Inverness (GB); Lorn Macdonald, Inverness (GB)

(73) Assignee: AWS OCEAN ENERGY LIMITED, Inverness (UK)

(21) Appl. No.: 13/583,878

(22) PCT Filed: Mar. 11, 2011
(86) PCT No.: PCT/GB2011/000348

§ 371 Date: Mar. 22, 2013

(30) Foreign Application Priority Data
Mar. 11, 2010 (GB) 1004041.8

(51) Int. Cl. F03B 13/24

(52) U.S. Cl. CPC F03B 13/24
USPC 60/501

(57) ABSTRACT

An energy conversion device, a removable assembly for use with the energy conversion device and an associated methods. The energy conversion device comprises a flexible diaphragm configured to be located between a first fluid and a second fluid and being moveable in response to variations in at least one of the first and second fluids to permit energy transfer between said fluids; and a limit apparatus configured to limit movement of the diaphragm at a limit position, wherein the limit apparatus defines a contoured contact surface configured to be engaged by the diaphragm when in its limit position.

### FIELD OF THE INVENTION

The present invention relates to an energy conversion device, and an apparatus for limiting movement of a diaphragm in an energy conversion device, and in particular, but not exclusively, in a wave energy conversion device.

The present invention also generally relates to devices, apparatus and methods of protecting a diaphragm of an energy conversion device.

### BACKGROUND TO THE INVENTION

Various forms of energy conversion device are known in the art for the extraction of energy from renewable resources. One species of energy conversion device involves the extraction of energy from natural fluid motion, such as from wind, water currents, waves, tides, cascading fluids and the like. Such energy conversion devices typically operate by using fluid motion to drive a turbine to produce mechanical shaft work, which may then be used directly as an output, or to drive a generator to produce electricity.

Devices are known which are arranged to use natural fluid motion to directly drive a turbine. That is, a reaction surface of a turbine may be arranged to be directly exposed to natural fluid motion, such as in wind turbines. However, in some cases natural fluid motion may be relatively slow requiring gearing arrangements and the like to achieve a useable output. Also, where energy is to be extracted from liquids, such as tidal streams and wave motion, energy losses may become significant due to higher densities and inertial forces and the like. To address such issues it is known in the art to utilise an intermediary medium which itself is caused to flow along a controlled path by natural fluid motion in a separate fluid body. For example, liquid motion, such as wave motion, may be used to act on and displace a working surface which in turn drives air through a duct to drive a turbine. In such arrangements a large working surface may be provided to maximise energy extraction from the liquid, and the air duct may be formed with a relatively small cross-sectional area such that the energy from the liquid may be manifested as kinetic energy in the air stream, thus permitting relatively high speed operation of the turbine.

In some known designs a diaphragm is used as a working surface, wherein one side of the diaphragm is exposed to fluid motion, such as wave motion, and an opposite side is exposed to an intermediary medium, such as air. One such design is know as the floating CLAM device, as described in “The Clam Wave energy converter”, F. P. Lockett, Wave Energy Seminar, Institute of Mechanical Engineers, London, November 1991, pp 19-23. In this device a number of interconnected air cells each include a flexible diaphragm which separates an internal closed air system from the sea environment, wherein wave motion displaces the diaphragm to cause air flow between the cells and through Wells turbines which are coupled to generators.

However, in such devices the diaphragm is subjected to significant forces, and are thus in use exposed to extremely large strains which can adversely affect the life span of the diaphragm. For example, the diaphragm may be subject to buckling or wrinkling, for example at any points of connection to the individual air cells and/or close to a connection, e.g. further into the body of the material. Such buckling may push the material over its safe working limits, and can lead to potential failure. Furthermore, during operation, the diaphragm may be moved beyond operational limits and may thereby be subjected to an undesirably large maximum strain, which may damage the material of the diaphragm. It has been proposed in the art to address this issue by increasing the thickness of those areas of the diaphragm which are most likely to be susceptible to buckling or wrinkling. However, this approach can create a number of additional problems. For example, the increased thickness can increase the manufacturing complexities and costs, create difficulties in designing specialised clamping arrangements, produce high loads at the points of connection, increase strain energy and therefore hysteresis losses in the diaphragm material, and the like.

Furthermore, in some existing devices a degree of pressurisation of air within each cell is established to permit efficient use while submerged within the sea. However, the pressurised air may exert significant forces on any diaphragm while positioned in low water depths. It will be appreciated that problems with wrinkling, buckling and/or excessive strain, analogous to those described above may occur in low water depths or pressures. In particular, it will be appreciated that such problems may occur regardless of the direction of any net force acting on the diaphragm, for example, inwardly or outwardly.

### SUMMARY OF THE INVENTION

According to a first aspect of the present invention there is provided an energy conversion device comprising:

a flexible diaphragm configured to be located between a first fluid and a second fluid and being moveable in response to variations in at least one of the first and second fluids to permit energy transfer between said fluids; and

a limit apparatus configured to limit movement of the diaphragm at a limit position, wherein the limit apparatus defines a contoured contact surface configured to be engaged by the diaphragm when in its limit position.

In use, movement of the diaphragm may be limited at a desired position, which may be selected to protect the diaphragm from damage, for example from excessive strains and loads, wrinkling, buckling or the like. Furthermore, the limit apparatus may provide a degree of support to the diaphragm at the limit position, to further assist to protect the diaphragm.

The diaphragm may be arranged to adopt the same contoured shape as the contact surface of the limit apparatus when said diaphragm is moved to its limit position. This may assist to minimise any significant localised contact forces or point loading being applied to the diaphragm. Further, the contoured contact surface may assist to retain the diaphragm in a desired shape, which may assist to prevent undesired movement or flexing of the diaphragm, which might otherwise cause fatigue, hysteresis losses and the like. Furthermore, the contoured contact surface may permit the diaphragm to be evenly supported, which may assist in improving a uniform transference of any loading to an associated support structure, for example.

The contoured contact surface may be non-planar.

The diaphragm may be configured to adopt a generic shape over a working range of movement. In use, the actual shape of the diaphragm may change, however the same generic shape may be recognisable throughout a range of movement of the diaphragm. One extreme position of the working range of movement of the diaphragm may be defined by the limit apparatus. The contoured contact surface of the limit apparatus may be arranged to closely compliment or correspond to the generic shape of the diaphragm at its limit position. This may advantageously permit the diaphragm to be limited in movement while maintaining a substantially constant shape. Further, this arrangement may permit the diaphragm to continuously adopt the same generic shape. Otherwise, forcing the diaphragm to adopt a substantially different shape to that which the diaphragm naturally seeks to adopt at the limit position may result in undesirable wrinkling, strains, hysteresis, abrasion or the like, which may adversely affect the integrity of the diaphragm.

A generic shape of the diaphragm, such as a cross-sectional shape along one plane, such as a plane normal to an operating surface, may be determined in accordance with a pressure regime associated with the first and second fluids. For example, in one embodiment the diaphragm may be configured to adopt a general cross-sectional S-shape over a working range, for example where the diaphragm is submerged in at least one of the first and second fluids. In this arrangement the limit apparatus may define an S-shaped contoured contact surface, at least across one plane, such as a vertical plane.

The limit apparatus may define a substantially continuous contact surface. Alternatively, the limit apparatus may define a discontinuous contact surface. For example, the limit apparatus may be provided in the form of a cage, multiple spars or the like.

The limit apparatus may comprise a single component. Alternatively, the limit apparatus may comprise multiple components arranged to be assembled to collectively define the limit apparatus.

The limit apparatus may comprise a fluid communication arrangement configured to permit fluid communication of at least one of the first and second fluids. This arrangement may permit use of the limit apparatus while retaining exposure of the diaphragm to the first or second fluid. The fluid communication arrangement may comprise at least one aperture.

The diaphragm may be configured to provide a flexible barrier between the first and second fluids. The diaphragm may be configured to isolate the first and second fluids, such that energy transfer is achieved exclusively across the diaphragm.

The diaphragm may be arranged to be supported about its periphery, for example about its edges. In one embodiment the edges of the diaphragm may be secured to a frame of the energy conversion device, wherein the diaphragm is configured to move relative to the frame to permit energy transfer between the first and second fluids. The frame may be provided as a separate component. Alternatively, the frame may define an integral part of the energy conversion device.

The limit apparatus may be arranged to be supported on the energy conversion device. The limit apparatus may be configured to be supported on a frame, such as the same frame which supports the diaphragm. In one embodiment the diaphragm may be supported on the limit apparatus, and the limit apparatus supported and secured to the energy conversion device, for example to a frame of the energy conversion device. However, in other embodiments the limit apparatus may be supported separately of the diaphragm.

The diaphragm may be arranged to be supported about at least a portion of its periphery in a predefined shape. Opposing side edges of the diaphragm may be supported in a predefined shape. In one embodiment the predefined shape may generally compliment or correspond to a generic shape of the diaphragm when in use. For example, in some embodiments the diaphragm may be supported at its periphery in an S-shape. Such an S-shaped support arrangement is disclosed in WO 2009/138740, the disclosure of which is incorporated herein. The energy conversion device may comprise an S-shaped frame configured to support periphery portions of the diaphragm, such as side edge periphery portions.

The limit apparatus may define a contoured contact surface configured to provide a varying degree of movement limitation across the diaphragm. For example, the contoured contact surface may be arranged to provide a greater degree of movement limitation to edge regions, such as side edge regions, of the diaphragm than a central region of the diaphragm. In this arrangement the central region of the diaphragm may be permitted to travel further than the edge regions. This may assist to limit loading and strains experienced by the edge region of the diaphragm, which in some embodiments may define regions of connection to the energy conversion device, such as via a frame. Also, this arrangement may assist to prevent wrinkling of the diaphragm at its edge regions. Further, this arrangement may protect the edge regions as noted above, while still permitting a sufficient degree of motion of the central region for efficient energy transfer between the first and second fluids.

The energy conversion device may comprise a bend restrictor arrangement mounted adjacent a periphery region of the diaphragm. The bend restrictor arrangement may be configured to limit the degree of bending of the diaphragm at a periphery portion, to thus minimise excessive strains and contact pressures at this region. The bend restrictor arrangement may be configured to limit any abrupt deflection point within the diaphragm. For example, the bend restrictor arrangement may be configured to prevent rolling about a sharp edge. The bend restrictor arrangement may comprise a curved surface. The bend restrictor arrangement may extend partially or fully around the periphery of the diaphragm. The bend restrictor arrangement may be provided on one or both sides of the diaphragm. The bend restrictor arrangement may be provided separately of the limit apparatus. Alternatively, the bend restrictor arrangement may be at least partially provided with, on or as an integral part of the limit apparatus.

In some embodiments the energy conversion device may comprise a diaphragm having a sheet material with one or more reinforcement cords arranged in a required direction. The use of a bend restrictor arrangement may assist to minimise the possibility of cords garrotting through the sheet material.

A bend restrictor arrangement may assist to minimise any wrinkling of the diaphragm, for example at its edge regions.

The energy conversion device may comprise a cell adapted to be at least partially immersed within the first fluid, wherein the cell defines an internal chamber configured to accommodate the second fluid. The diaphragm may define a wall structure of the cell, such that movement of the diaphragm may cause a variation in the chamber volume. In this arrangement variations in the first fluid may cause movement of the diaphragm in a direction to reduce the internal volume causing the second fluid to be expelled from the chamber. Further, variations in the first fluid may cause movement of the diaphragm to increase the chamber volume causing the second fluid to be drawn into the chamber. In some embodiments movement of the second fluid to and from the chamber may drive a turbine to produce mechanical work. This mechanical work may be used to drive a generator to generate electricity. In alternative embodiments movement of the diaphragm may be used to pump the second fluid through the chamber, for example in bilge pump applications or the like.

In use, the energy conversion device may be configured for use with a first fluid subject to cyclical variations, such as pressure variations. This may permit the second fluid to be cyclically moved to and from the chamber of the cell, thus permitting continuous energy extraction from the movement of the second fluid. This may permit the energy conversion device to have application in converting energy from wave motion, such as natural sea wave motion.

The energy conversion device may comprise a plurality of cells. The plurality of cells may function independently, or in combination by being interconnected. The cells may be arranged in a circular arrangement.

The limit apparatus may comprise a tether arrangement configured to tether a portion of the diaphragm to the contoured surface of the limit apparatus. The tether arrangement may permit a separation distance of the diaphragm from the contour surface to be limited. This may therefore permit the limit apparatus to limit movement of the diaphragm at a first limit position by engagement with the contoured contact surface, and limit movement of the diaphragm at a second limit position by use of the tether arrangement. The tether arrangement may comprise one or more straps, which may be inelastic, elastic or the like.

The limit apparatus may be located on a single side of the diaphragm. In one arrangement the limit apparatus may be arranged on an inside of the diaphragm and thus arranged to limit inward movement of the diaphragm relative to a cell by engagement of the diaphragm with the contoured contact surface. However, in alternative arrangements the limit apparatus may be arranged on an outside of the diaphragm.

The energy conversion device may comprise a first limit apparatus mounted on an inside of the diaphragm and a second limit apparatus mounted on an outside of the diaphragm.

The energy conversion device may comprise a strap arrangement located on one side of the diaphragm and arranged to limit movement of the diaphragm. The strap arrangement may be configured to brace the diaphragm when positioned in a predetermined limit position. This may prevent the diaphragm being exposed to excessive strains and loads and the like. The strap arrangement may extend at least partially across a surface of the diaphragm. The strap arrangement may extend between side edges of the diaphragm.

The energy conversion device may comprise a limit apparatus located on one side of the diaphragm, and a strap arrangement located on a opposite side of the diaphragm. In one embodiment the limit apparatus may be located on an inside of the diaphragm, and the strap arrangement may be located on an outside of the diaphragm.

In embodiments of the invention the first fluid may comprise a liquid, such as water, and the second fluid may comprise a gas, such as air.

The limit apparatus may be formed of composite material, such as a fibre based composite, such as glass reinforced plastic.

The flexible diaphragm and the limit apparatus may be removably attached to the energy conversion device. The flexible diaphragm and the limit device may be comprised in a module, cassette or apparatus that is removably attached to the energy conversion device.

According to a second aspect of the present invention there is provided an apparatus configured to limit the movement of a diaphragm of an energy conversion device, said diaphragm arranged to be moveable to transfer energy between a first fluid located on one side of the diaphragm and a second fluid located on an opposite side of the diaphragm, wherein the apparatus defines a contoured contact surface configured to be engaged by the diaphragm when in its limit position.

The apparatus according to the second aspect may comprise the features of the limit apparatus defined in the first aspect.

According to a third aspect of the present invention there is provided a method of limiting the movement of a diaphragm in an energy conversion device, the method comprising:

providing a limit apparatus defining a contoured contact surface; and

arranging the limit apparatus relative to a diaphragm such that the diaphragm may contact the contoured contact surface of the limit apparatus at a limit position.

According to a fourth aspect of the present invention there is provided an energy conversion device comprising:

a flexible diaphragm configured to be located between a first fluid and a second fluid and being moveable in response to variations in at least one of the first and second fluids to permit energy transfer between said fluids; and

a strap arrangement located on one side of the diaphragm and arranged to limit movement of the diaphragm.

Other aspects of the present invention may relate to a bend restrictor arrangement, such as that defined above.

Further aspects of the present invention may relate to methods of protecting a diaphragm of an energy conversion device using one or more features defined above.

Other aspects of the present invention may relate to methods of converting energy using an energy conversion device according to any other aspect.

According to a fifth aspect of the present invention there is provided an assembly for mounting to an energy conversion device, the assembly comprising a flexible diaphragm supported on a limit apparatus, the flexible diaphragm being configured to be located between a first fluid and a second fluid and being moveable in response to variations in at least one of the first and second fluids to permit energy transfer between said fluids; and the limit apparatus being configured to limit movement of the diaphragm at a limit position, wherein the limit apparatus defines a contoured contact surface configured to be engaged by the diaphragm when in its limit position.

The diaphragm and the limit apparatus may together form a container to contain fluid.

The assembly may be removably mountable to the energy conversion device.

The assembly may comprise a frame and wherein the edges of the diaphragm are secured to the frame and/or the limit apparatus is supported on the frame.

The assembly may be adapted to be mounted to an energy conversion device according to the first aspect.

The diaphragm and/or limit apparatus and/or frame may comprise features described in relation to the diaphragm and/or limit apparatus and/or frame of the first aspect.

According to a further aspect of the invention is a method for replacing or attaching or removing an assembly according to the fourth aspect of invention to/from an energy conversion device according to the first aspect.

It will be appreciated that features analogous to those described in relation to any of the above aspects of invention may be applicable to any of the other aspects of invention.

### BRIEF DESCRIPTION OF THE DRAWINGS

These and other aspect of the present invention will now be described, by way of example only, with reference to the accompanying drawings, in which:

FIG. 1 shows an energy conversion device, specifically a wave energy conversion device, in accordance with an embodiment of the present invention;

FIG. 2 is a cross sectional view of the wave energy conversion device of FIG. 1, which demonstrates a principle of operation of a single cell of the wave energy conversion device;

FIG. 3 shows the energy conversion device of FIG. 1, with some diaphragms removed to reveal individual limit apparatuses according to an embodiment of the present invention;

FIG. 4 is a perspective sectional view of the wave energy conversion device of FIG. 1;

FIG. 5 is a perspective view of the limit apparatus first shown in FIG. 3;

FIGS. 6A, 6B and 6C are front, side and bottom views, respectively, of the limit apparatus of FIG. 5; FIG. 7 is a cross sectional view of an energy conversion device in accordance with a modified embodiment of the present invention; and

FIG. 8 shows a portion of an energy conversion device in accordance with a further modified embodiment of the present invention.

### DETAILED DESCRIPTION OF THE DRAWINGS

A wave energy conversion device, generally identified by reference numeral 10, is shown in FIG. 1, wherein the device 10 is configured to be partially immersed within the sea to extract energy from wave motion, as will be discussed in further detail below. The device 10 comprises a plurality of interconnected cells 12 provided in a circular arrangement, wherein each cell 12 defines an internal air filled chamber which is isolated from the surrounding sea water by individual flexible diaphragms 14 which in the present embodiment are made of fibre reinforced rubber. In use, the diaphragms 14 are caused to move in response to wave motion, thus modifying the internal volume of the respective cell chambers to effect movement of air therebetween. This air movement is used to drive one or more turbines (not shown), such as Wells turbines to produce mechanical work, which may be used to drive one or more generators.

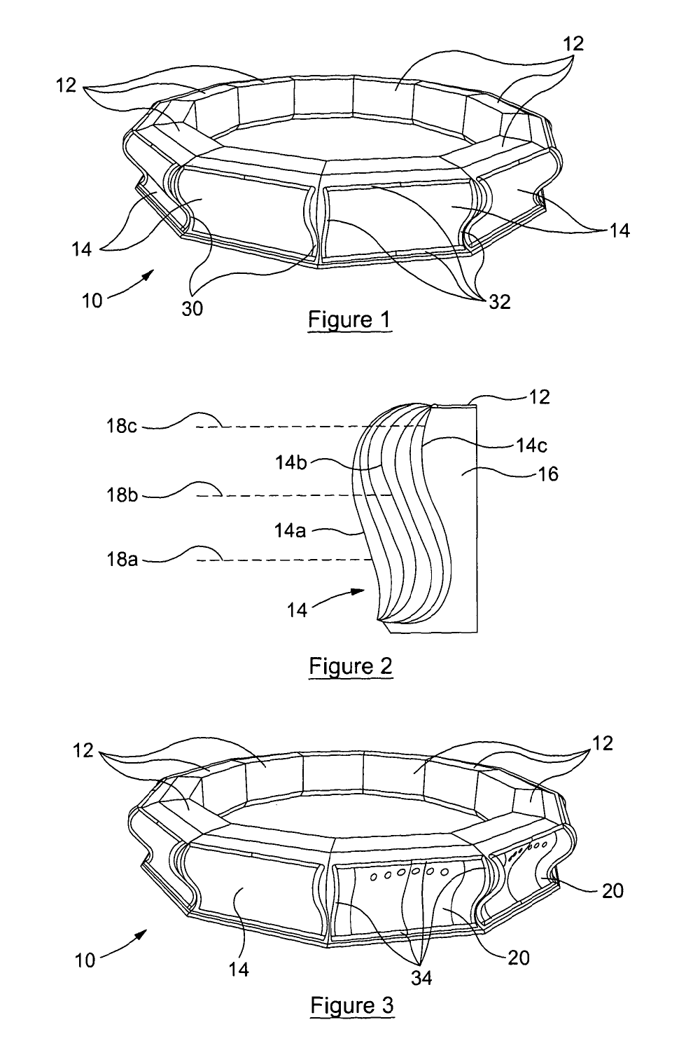

The principle of operation of the device 10 will now be described with reference to FIG. 2 which is a vertical cross-sectional view of a single cell 12 showing an associated internal chamber 16 and diaphragm 14. It should be understood that certain features of the device 10 have been omitted from FIG. 2 for purposes of clarity. In particular, a limit apparatus, which will be described in detail below, is not shown in FIG. 2. Furthermore, FIG. 2 shows the diaphragm 14 in multiple operational positions which are associated with the depth of immersion of the cell within the sea, which varies in accordance with passing waves. Specifically, a low level of immersion identified by water level 18a will result in a diaphragm profile 14a. An intermediate level of immersion identified by water level 18b will result in inward motion of the diaphragm 14 due to increasing water pressure, resulting in a diaphragm profile 14b and a corresponding reduction in the volume of the chamber 16. A high level of immersion identified by water level 18c will result in further inward movement of the diaphragm 14 to adopt profile 14c causing a further reduction in the volume of the chamber 16. Cyclical variations in the water level by wave motion will therefore provide cyclical variations in the volume of the chamber to continuously impart movement of the contained air to drive one or more associated turbines.

As illustrated, throughout operation of the device 10 the diaphragm 14 assumes a general S-shape profile. This is because at any point in time the pressure of the air within the chamber 16 is constant over its height while the hydrostatic pressure of the water increases with depth. Although the actual shape of the diaphragm 14 changes according to immersion depth, the S-shape profile is recognisable throughout and as such this S-shape may be considered to define a generic operational shape of the diaphragm 14.

During use the diaphragms 14 are subject to considerable loads and strains, which may adversely affect their useful life by causing material fatigue, damaging reinforcing components, abrasion, material hysteresis and the like. For example, the diaphragms 14 may be subject to significant strain at opposite extremes of water depths, which may occur in rough seas and/or it may also occur in normal seas depending on the turbine settings. Further, the diaphragms 14 may be subject to significant loads and strains in those regions of connection to the individual cells 12. Additionally, the diaphragms may be subject to wrinkling or buckling at their edge regions. Features and aspects of the present invention seek to provide a degree of protection to the membranes, examples of which will be discussed below.

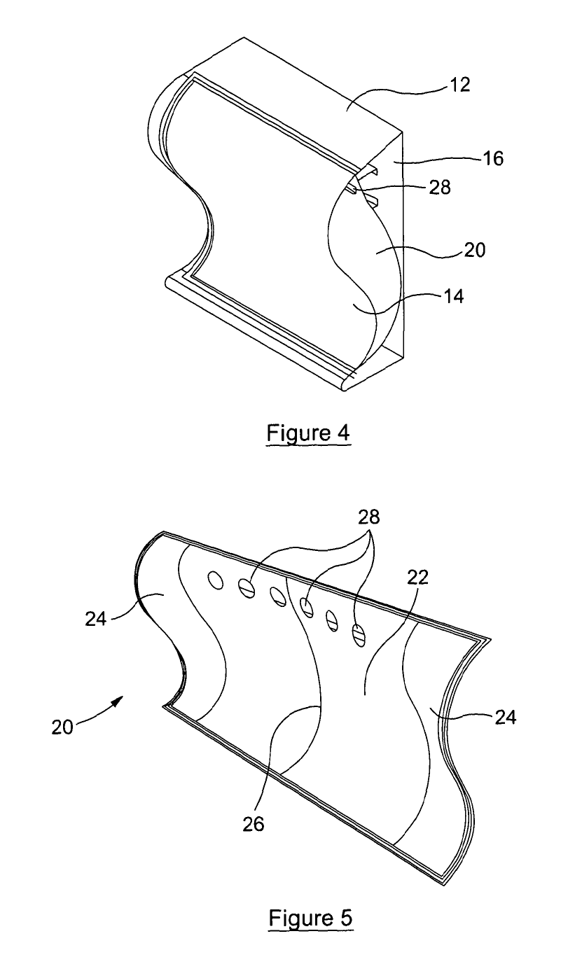

Reference is additionally made to FIG. 3, in which the device 10 is shown with a diaphragm 14 removed from two cells 12 to reveal respective limit apparatuses 20 according to an embodiment of the present invention. Each limit apparatus 20 is mounted to a frame of a respective cell and located on the inside of each diaphragm 14. A perspective sectional view through a cell 12 showing the relative locations of a diaphragm 14 and a limit apparatus 20 is shown in FIG. 4. In use, each limit apparatus 20 serves to limit the inward movement of a respective diaphragm 14 at a limit position. This arrangement may thus serve to protect each diaphragm 14 from excessive inward displacement, for example due to significant immersion depths, although excessive inward displacement may also occur in normal seas, depending on the turbine settings.

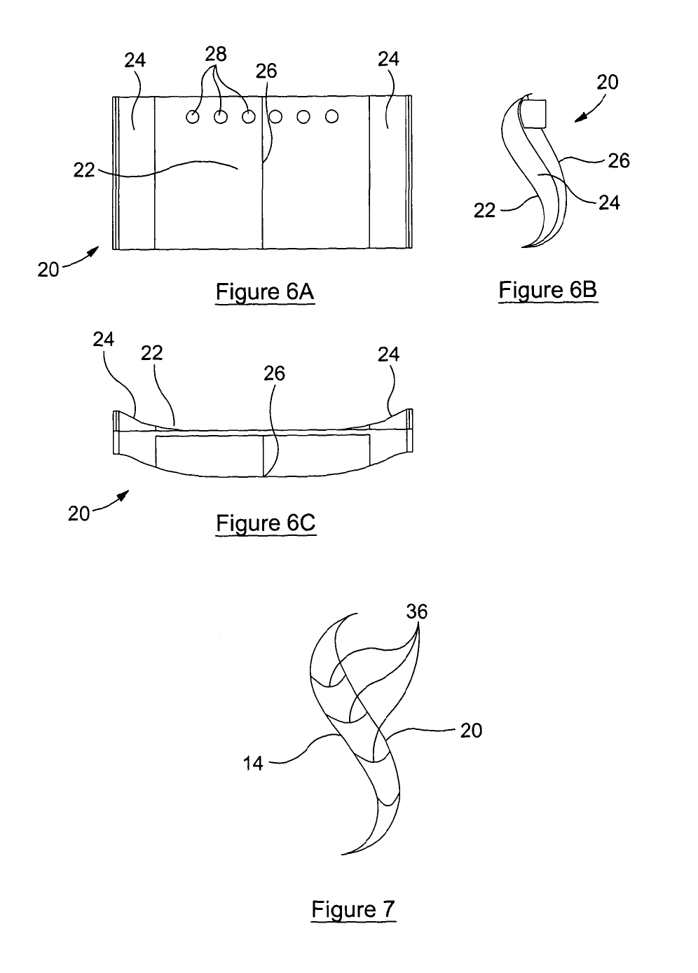

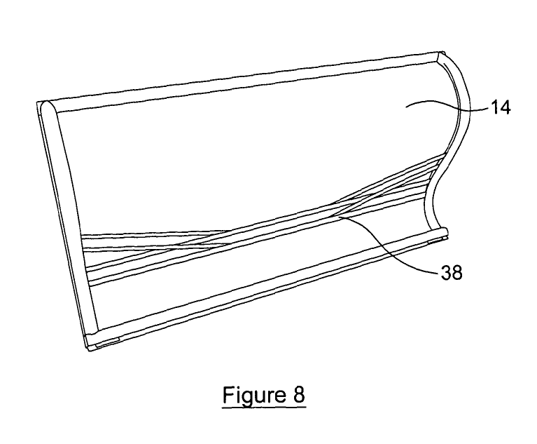

A perspective view of a limit apparatus 20 removed from the device 10 is shown in FIG. 5, and respective front, side and bottom views of the limit apparatus 20 are shown in FIGS. 6A, 6B and 6C.

The limit apparatus 20 defines a non-planar contoured contact surface 22 which is engaged by an associated diaphragm 14 when in its limit position, such that the diaphragm 14 will adopt the same contoured shape as the contact surface 22. This may assist to minimise any significant localised contact forces or point loading being applied to the diaphragm 14. Further, the contoured contact surface 22 may assist to retain the diaphragm 14 in a desired shape, which may assist to prevent undesired movement or flexing of the diaphragm, which might otherwise cause fatigue, hysteresis losses and the like. Also, the contoured contact surface may assist to support the diaphragm evenly across its surface, which may permit a better transference of loads to the support structure.

As illustrated, the contoured contact surface 22 of the limit apparatus 20 is formed to be generally S-shaped in a vertical plane. This particular contour or profile is selected to closely compliment or correspond to the generic operational S-shape of the diaphragm. This arrangement may permit the diaphragm 14 to continuously adopt the same generic shape. Otherwise, forcing the diaphragm 14 to adopt a substantially different shape to its natural generic operational shape may result in undesirable wrinkling, strains, hysteresis, abrasion or the like, which may adversely affect the integrity of the diaphragm 14.

Further, the contoured contact surface 22 of the limit apparatus 20 has a varying profile along a horizontal plane. This varying profile provides a varying degree of movement limitation across an associated diaphragm, from one vertical side to the other. For example, the contoured contact surface 22 is arranged to provide a greater degree of movement limitation at its side edge regions 24 than at its central region 26. This may therefore permit the central region of an associated diaphragm 14 to travel further than its edge regions. This may assist to limit loading and strains experienced by the edge regions of the diaphragm 14. Also, this arrangement may assist to prevent wrinkling of the diaphragm 14 at its edge regions. Further, this arrangement may protect the edge regions of an associated diaphragm as noted above, while still permitting a sufficient degree of motion of the central region for efficient energy transfer between the first and second fluids.

As illustrated at least in FIGS. 4 and 5, the limit apparatus 20 comprises a plurality of apertures 28 which in use permit fluid communication of air therethrough, to maintain the inner face of an associated diaphragm 14 in communication with the chamber 16 of an associated cell 12. Although multiple apertures 28 are shown in the present embodiment, a single aperture may be provided, and any aperture may take any suitable form, such as round, oval, elongate or the like. Furthermore, one or more apertures may be configured to provide a degree of control to the flowing air, for example to reduce air turbulence and the like.

In addition to limiting loading and strains on each diaphragm using the limit apparatus 20, the side edges 30 of each diaphragm 14 are secured to the respective cells 12 along an S-shape profile, as shown in FIG. 1, which assists to prevent excessive strains and loads being established at the edge regions due to significant shape transitions across each diaphragm 14, which may be present where straight edge connections are used.

Further, external curved bend restrictor elements 32 are located externally around the entire periphery of each diaphragm 14, as shown in FIG. 1. Also, internal curved bend restrictor elements 34 are located internally around the entire periphery of each diaphragm 14, as shown in FIG. 3. These bend restrictor elements 32, 34 are configured to limit the degree of bending of the diaphragm at a periphery portion, to thus minimise excessive strains and contact pressures at this region. Further, the curved nature of the elements 32, 34 limit any abrupt deflection point within the diaphragms 14. For example, the bend restrictor elements 32, 34 may be configured to prevent rolling of the diaphragms 14 about a sharp edge. Also, in some arrangements the diaphragm may comprise one or more internal reinforcing cords, and in such cases the bend restrictor elements may assist to prevent garrotting of the cords through the diaphragm 14. It should be noted that the internal bend restrictor elements 34 may be provided as separate components. However, in other embodiments the internal bend restrictor elements 34 may be integral with the limit apparatuses 20.

As described above, inward movement of each diaphragm 14 may be limited by use of a limit apparatus 20. However, it should be understood that a similar limit apparatus may be located externally of a diaphragm 14 to thus limit outward movement.

In other embodiments, as demonstrated in FIG. 7, outward movement of a diaphragm 14 may be limited by use of a tether arrangement comprising a number of tethers 36 which extend between an internally mounted limit apparatus 20 and an inner surface of a diaphragm 14. The tether arrangement may establish a separation limit of the diaphragm 14 from the limit apparatus 20.

In other embodiments, as shown in FIG. 8, a strap arrangement 38 may be provided and located across a surface of a diaphragm 14 to limit movement of said diaphragm. In one arrangement such a strap arrangement 38 may be located across an outer surface of a diaphragm 14 in order to limit outward movement of the diaphragm. Such outward limitation may be required in situations where no or low water pressure acts against an outer surface of the diaphragm, such that internal air pressure may cause the diaphragm to bulge outwardly. The strap is not connected to the diaphragm and therefore, in the above arrangement, only acts on the diaphragm when it is moving outwards.

It should be understood that the embodiments described herein are merely exemplary and that various modifications may be made thereto without departing from the scope of the present invention. For example, an energy conversion device may comprise a single cell. Further, where multiple cells are used these may be arranged in any suitable form, such as linearly. Also, in the embodiment shown the limit apparatus is formed of a single component having a substantially continuous contact surface. However, in other embodiments a limit apparatus may be provided by multiple components which may be assembled together. Also a limit apparatus may be used which includes a discontinuous contact surface, such as being in the form of a cage, being defined by a number of separated spars or the like. Further, a number of different features have been disclosed for use in protecting a diaphragm when in use, such as the limit apparatus, S-shaped edge connection, tether arrangement and strap arrangement. It should be understood that aspects of the present invention may relate to such features provided individually or in any suitable combination. Furthermore, whilst embodiments have been described above in which the contact surface 22 of the limit apparatus 20 is formed to be generally S-shaped in a vertical plane, in optional embodiments, at least part of the contact surface 22 may be configured such that it is non S-shaped in a vertical plane, for example, the contact surface 22 may be S-shaped at opposing sides but may take a different configuration or profile towards its centre, such as a C-shape or offset C-shape.

1-66. (canceled)

67. An energy conversion device comprising:
a flexible diaphragm configured to be located between a first fluid and a second fluid and being moveable in response to variations in at least one of the first and second fluids to permit energy transfer between said fluids; and
a limit apparatus configured to limit movement of the diaphragm at a limit position, wherein the limit apparatus defines a contoured contact surface configured to be engaged by the diaphragm when in its limit position.

68. An energy conversion device according to claim 67, wherein the diaphragm is arranged to adopt the same contoured shape as the contact surface of the limit apparatus when said diaphragm is moved to its limit position.

69. An energy conversion device according to claim 67, wherein the contoured contact surface is non-planar.

70. An energy conversion device according to claim 67, wherein the diaphragm is configured to adopt a generic shape over a working range of movement.

71. An energy conversion device according to claim 70, wherein one extreme position of the working range of movement of the diaphragm is defined by the limit apparatus.

72. An energy conversion device according to claim 70, wherein the contoured contact surface of the limit apparatus is arranged to closely compliment or correspond to the generic shape of the diaphragm at its limit position.

73. An energy conversion device according to claim 70, wherein the generic shape of the diaphragm is configured to adopt a general cross-sectional S-shape over a working range.

74. An energy conversion device according to claim 67, wherein the limit apparatus defines an S-shaped contoured contact surface, at least across one plane.

75. An energy conversion device according to claim 67, wherein the limit apparatus defines a substantially continuous contact surface.

76. An energy conversion device according to claim 1, wherein the limit apparatus defines a discontinuous contact surface.

77. An energy conversion device according to claim 76, wherein the limit apparatus is provided in the form of a cage or multiple spars.

78. An energy conversion device according to claim 67, wherein the limit apparatus comprises a fluid communication arrangement configured to permit fluid communication of at least one of the first and second fluids.

79. An energy conversion device according to claim 78, wherein the fluid communication arrangement comprises at least one aperture.

80. An energy conversion device according to claim 67, wherein the diaphragm is arranged to be supported about its periphery.

81. An energy conversion device according to claim 80, wherein the edges of the diaphragm are secured to a frame of the energy conversion device, wherein the diaphragm is configured to move relative to the frame to permit energy transfer between the first and second fluids.

82. An energy conversion device according to claim 67, wherein the limit apparatus is supported on a frame.

83. An energy conversion device according to claim 82, wherein, the limit apparatus is supported on the same frame that supports the diaphragm.

84. An energy conversion device according to claim 67, wherein the diaphragm is supported on the limit apparatus, and the limit apparatus is supported and secured to the energy conversion device.

85. An energy conversion device according to claim 84, wherein the limit apparatus is supported and secured to a frame of the energy conversion device.

86. An energy conversion device according to claim 67, wherein the limit apparatus is supported separately of the diaphragm.

87. An energy conversion device according to claim 83, wherein the diaphragm is arranged to be supported about at least a portion of its periphery in a predefined shape.

88. An energy conversion device according to claim 83, wherein opposing side edges of the diaphragm are supported in a predefined shape.

89. An energy conversion device according to claim 88, wherein the predefined shape generally compliments or corresponds to a generic shape of the diaphragm when in use.

90. An energy conversion device according to claim 83, wherein the diaphragm is supported at its periphery in an S-shape.

91. An energy conversion device according to claim 83, wherein the energy conversion device comprises an S-shaped frame configured to support periphery portions of the diaphragm.

92. An energy conversion device according to claim 67, wherein the limit apparatus defines a contoured contact surface configured to provide a varying degree of movement limitation across the diaphragm.

93. An energy conversion device according to claim 92, wherein the contoured contact surface is arranged to provide a greater degree of movement limitation to edge regions of the diaphragm than a central region of the diaphragm.

94. An energy conversion device according to claim 67, comprising a bend restrictor arrangement mounted adjacent a periphery region of the diaphragm.

95. An energy conversion device according to claim 94, wherein the bend restrictor arrangement is configured to limit the degree of bending of the diaphragm at a periphery portion.

96. An energy conversion device according to claim 94, wherein the bend restrictor arrangement is configured to limit any abrupt deflection point within the diaphragm.

97. An energy conversion device according to claim 94, wherein the bend restrictor arrangement comprises a curved surface.

98. An energy conversion device according to claim 94, wherein the bend restrictor arrangement extends partially or fully around the periphery of the diaphragm.

99. An energy conversion device according to claim 94, wherein the bend restrictor arrangement is provided on one or both sides of the diaphragm.

100. An energy conversion device according to claim 94, wherein the bend restrictor arrangement is provided separately of the limit apparatus.

101. An energy conversion device according to claim 94, wherein the bend restrictor arrangement is at least partially provided with, on or as an integral part of the limit apparatus.

102. An energy conversion device according to claim 67, wherein the diaphragm comprises a sheet material with one or more reinforcement cords arranged in a required direction.

103. An energy conversion device according to claim 67, comprising a cell adapted to be at least partially immersed within the first fluid, wherein the cell defines an internal chamber configured to accommodate the second fluid.

104. An energy conversion device according to claim 103, wherein the diaphragm defines a wall structure of the cell, such the diaphragm is movable to cause a variation in the chamber volume.

105. An energy conversion device according to claim 104, wherein the device is arranged such the diaphragm is movable in a direction to reduce the internal volume by variations in the first fluid to cause the second fluid to be expelled from the chamber and/or the diaphragm is movable by variations in the first fluid to increase the chamber volume causing the second fluid to be drawn into the chamber.

106. An energy conversion device according to claim 105, wherein movement of the second fluid to and from the chamber drives a turbine to produce mechanical work and/or movement of the diaphragm is usable to pump the second fluid through the chamber.

107. An energy conversion device according to claim 67, wherein, in use, the energy conversion device is configured for use with a first fluid subject to cyclical variations, such as pressure variations.

108. An energy conversion device according to claim 103, comprising a plurality of cells.

109. An energy conversion device according to claim 108, wherein the plurality of cells function independently, or in combination by being interconnected.

110. An energy conversion device according to claim 108, wherein the cells are arranged in a circular arrangement.

111. An energy conversion device according to claim 67, wherein, the limit apparatus comprises a tether arrangement configured to tether a portion of the diaphragm to the contoured surface of the limit apparatus.

112. An energy conversion device according to claim 111, wherein the tether arrangement comprises one or more straps.

113. An energy conversion device according to claim 67, wherein the limit apparatus is located on a single side of the diaphragm.

114. An energy conversion device according to claim 67, wherein the limit apparatus is arranged on an inside of the diaphragm and arranged to limit inward movement of the diaphragm relative to a cell by engagement of the diaphragm with the contoured contact surface.

115. An energy conversion device according to claim 67, wherein the energy conversion device comprises a first limit apparatus mounted on an inside of the diaphragm and a second limit apparatus mounted on an outside of the diaphragm.

116. An energy conversion device according to claim 67, comprising a strap arrangement located on one side of the diaphragm and arranged to limit movement of the diaphragm.

117. An energy conversion device according to claim 116, wherein the strap arrangement is configured to brace the diaphragm when positioned in a predetermined limit position.

118. An energy conversion device according to claim 116, wherein the strap arrangement extends at least partially across a surface of the diaphragm.

119. An energy conversion device according to claim 118, wherein the strap arrangement extends between side edges of the diaphragm.

120. An energy conversion device according to claim 67, comprising a limit apparatus located on one side of the diaphragm, and a strap arrangement located on a opposite side of the diaphragm.

121. An energy conversion device according to claim 120, wherein the limit apparatus is located on an inside of the diaphragm, and the strap arrangement is located on an outside of the diaphragm.

122. An energy conversion device according to claim 67, wherein the limit apparatus is formed of composite material, such as a fibre based composite, such as glass reinforced plastic.

123. An apparatus configured to limit the movement of a diaphragm of an energy conversion device, said diaphragm arranged to be moveable to transfer energy between a first fluid located on one side of the diaphragm and a second fluid located on an opposite side of the diaphragm, wherein the apparatus defines a contoured contact surface configured to be engaged by the diaphragm when in its limit position.

124. A method of limiting the movement of a diaphragm in an energy conversion device, the method comprising:
providing a limit apparatus defining a contoured contact surface; and
arranging the limit apparatus relative to a diaphragm such that the diaphragm contacts the contoured contact surface of the limit apparatus at a limit position.

125. An energy conversion device comprising:
a flexible diaphragm configured to be located between a first fluid and a second fluid and being moveable in response to variations in at least one of the first and second fluids to permit energy transfer between said fluids; and
a strap arrangement located on one side of the diaphragm and arranged to limit movement of the diaphragm.

126. An energy conversion device according to claim 125, wherein the flexible diaphragm and the limit apparatus are removably attached to the energy conversion device.

127. An energy conversion device according to claim 126, wherein the flexible diaphragm and the limit device are comprised in a module that is removably attached to the energy conversion device.

128. An assembly for mounting to an energy conversion device, the assembly comprising a flexible diaphragm supported on a limit apparatus, the flexible diaphragm being configured to be located between a first fluid and a second fluid and being moveable in response to variations in at least one of the first and second fluids to permit energy transfer between said fluids; and the limit apparatus being configured to limit movement of the diaphragm at a limit position, wherein the limit apparatus defines a contoured contact surface configured to be engaged by the diaphragm when in its limit position.

129. An assembly according to claim 128, wherein the flexible diaphragm and the limit device together form a cell for fluid.

130. An assembly according to claim 128, wherein the assembly is removably mountable to the energy conversion device.

131. An assembly according to claim 128, wherein the assembly comprises a frame and wherein the edges of the diaphragm are secured to the frame and/or the limit apparatus is supported on the frame.

132. An assembly according to claim 128, wherein the assembly is adapted to be mounted to an energy conversion device according to claim 67.
